(19) United States
(12) Patent Application Publication
(10) Pub. No.: US 2024/0101283 A1
(43) Pub. Date: Mar. 28, 2024

(54) GRIPPER COMPRISING A RESETABLE SNAP-BAND AND METHOD OF USE

(71) Applicant: Oceaneering International, Inc., Houston, TX (US)

(72) Inventor: Marc CHRISTENSEN, Friendswood, TX (US)

(73) Assignee: Oceaneering International, Inc., Houston, TX (US)

(21) Appl. No.: 18/476,952

(22) Filed: Sep. 28, 2023

Related U.S. Application Data
(60) Provisional application No. 63/410,808, filed on Sep. 28, 2022.

(51) Int. Cl. B64G 4/00; B25J 15/00; B25J 15/06; B25J 19/02; F16B 2/20

(52) U.S. Cl. CPC B64G 4/00; B25J 15/0028; B25J 15/0608; B25J 19/023; F16B 2/205; B64G 2004/005

(57) ABSTRACT

Two objects can be connected, e.g., in space, by maneuvering a gripper proximate a target which may be in space, commanding the snap-band controller to move the snap-band into its open position, maneuvering the gripper to a further position closer to the target to where the controllable snap-band, when closed, at least partially encircles the target, and commanding the snap-band controller to move the controllable snap-band into its closed position to at least partially encircle and capture the target. The gripper comprises a controllable snap-band comprising a selectable open position and closed position which is disposed about an external surface of a housing.

This application claims priority through U.S. Provisional Application 63/410,808 filed on Sep. 28, 2022.

### BACKGROUND

The claimed invention addresses a needed means for a gripping device to rapidly grip around a target object, including an irregularly shaped target and a sporadically moving target, such as in-space debris.

### FIGURES

Various figures are included herein which illustrate aspects of embodiments of the disclosed inventions.

FIG. 1 is a cutaway view in partial perspective of an exemplary embodiment with an exemplary remote controller;

FIG. 2 is a further view in partial perspective of an exemplary embodiment;

FIG. 3 is a view in partial perspective of an exemplary embodiment;

FIG. 4 is a view in partial perspective of an exemplary embodiment; and

FIG. 5 is a series of views in partial perspective of an exemplary embodiment as used.

### DESCRIPTION OF EXEMPLARY EMBODIMENTS

As used herein, a “target” is a relatively stationary or sporadically/randomly moving object to which a device equipped with gripper 1 needs to attach, even if the target comprises an irregular shape. Gripper 1 also reduces potential damage to a soft or non-rigid target during attachment and reduces the chance that a target will be knocked away during a gripping operation.

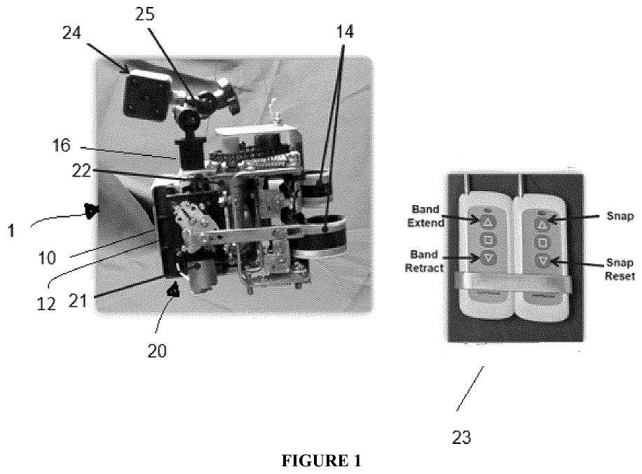

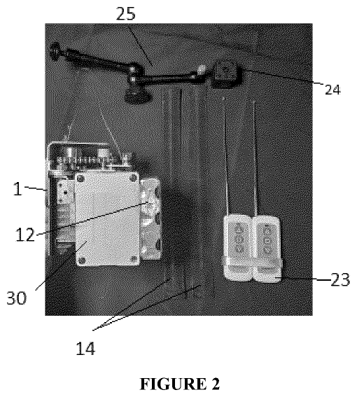

In a first embodiment, referring generally to FIG. 1, gripper 1 comprises housing 10; one or more power supplies 12 (FIG. 2) typically disposed at least partially within housing 10; one or more snap-bands 14, e.g., a plurality, disposed about an external surface of housing 10, each snap-band 14 comprising a selectable open position, e.g., a position when snap-band 14 is in an externally extended, linear configuration extending from an external surface of housing 15, and closed position, e.g., when snap-band 14 is an externally coiled or circumferential configuration; and snap-band controller 20 disposed at least partially within housing 10 where snap-band controller 20 is operatively connected to power supply 12 and is operatively connected to snap-bands 14 and is operative to selectively move snap-band 14 between it open position and its closed position

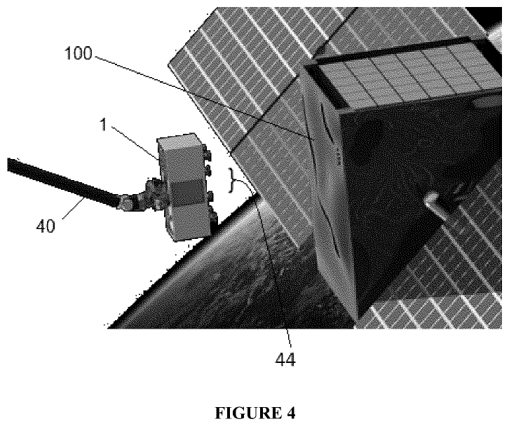

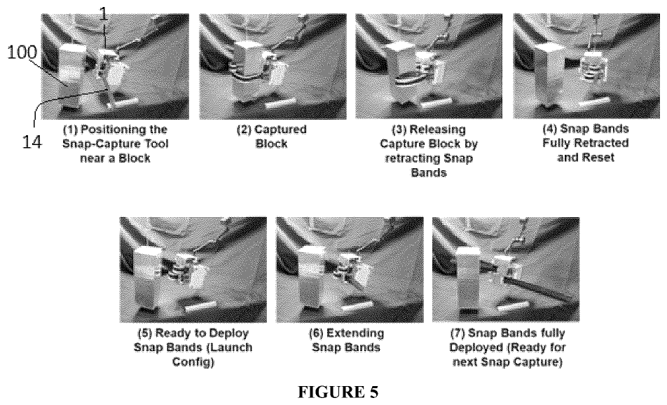

Generally, snap-band 14 comprises a bi-stable metal spring strip which may be coated, sleeved, and/or covered in cloth, plastic, or another coating, or the like, or a combination thereof. The coat, sleeve, or cover may comprise an organic component or an inorganic component. Referring additionally to FIG. 5, snap-band 14 has a first stable state as a substantially straight metal strip with a convex curve across its width and a second stable state where snap-band 14 is curved, e.g., into one or more, e.g., two, encircling hoops. When snap-band 14 is in its straight state and stable, its convex curve is forced into a partially flattened state and an unconstrained portion of snap-band 14 will attempt rapidly coil into one or more hoops and wrap around target 100 (FIG. 4) to grip it. Bending of snap-band 14 is an elastic deformation and snap-band 14 can be “reset” by forcing it to bend elastically from one stable structure to the other.

In embodiments, snap-band 14 is selectively detachable from snap-band controller 20, from housing 10, or from both snap-band controller 20 and housing 10.

Snap-band 14 may be configured to accommodate encircling an irregular shape, e.g., structurally link to target 100 and in-space debris. Typically, snap-band 14 comprises a rapid closing reaction time, e.g., a closing reaction time which is sufficiently fast to prevent a touched target 100 from reactively moving away. This reaction time is typically around or less than one second for a snap-band length of 12 inches or less.

In embodiments, gripper 1 is configured to accommodate sporadic/random motion between housing 15 and a moving target 100, e.g., a tumbling target.

A predetermined set of payload electronics 30 (FIG. 2) may be disposed at least partially within or otherwise attached to housing 10. Moreover, electro-magnet 44 (FIG. 4), which can be an permanent electro-magnet, may be disposed at least partially exposed through housing 10, e.g., to create a more rigid, secondary attachment to target 100.

Snap-band controller 20 is operative to selectively move snap-bands 14 between their open position, e.g., an extended position, and their closed position, e.g., a “snapped,” retracted, or coiled position. Snap-band controller 20 is also operative to selectively move snap-band 14 between an externally coiled position (potentially gripping an object such as target 100 (FIG. 4)) to an internally coiled position or to an open position to release gripper 1 from target 100.

In embodiments, gripper 1 further includes a snap-band extension guide that reshapes snap-band 14 so that it can then be commanded to extend in the open position from its closed position. The snap-band extension guide effectively pushes on a center width of snap-band 14 to force it from its closed shape into its open shape as it is commanded to be extended. In embodiments, still referring to FIG. 1, snap-band controller 20 further comprises one or more snap actuation motors or actuators 21, one or more snap-band motors or actuators 22 operatively connected to snap-band 14, and a separate control interface 23. It will be understood by one of ordinary skill in this art that control interface 23 can be a remote or local human interface device, a computerized controller, or the like, or a combination thereof.

Gripper 1 may further comprise support junction 16 disposed about a surface of housing 10. In these embodiments, arm 25 may be connected to support junction 16 and one or more devices such as camera 24. In addition, in embodiments snap-band 14 further comprise additional components such as electronics or reflective surfaces and gripper 1 may act as a payload when separated from gripper 1 and left behind on target 100.

In embodiments, gripper 1 may be attached to a robotic or support arm and act as a robotic end effector. In other embodiments, gripper 1 may be attached to self-propelled device such as a satellite bus.

In the operation of exemplary methods, referring back to FIG. 1 and generally to FIG. 5, two objects may be connected, e.g., in microgravity in-space environments, by maneuvering gripper 1 proximate target 100 where gripper 1 is as described above. Snap-band controller 20 is commanded, e.g., initially, to move snap-band 14 into its open position, e.g., by using snap-band motor 22 which is operatively connected to snap-band 14 and control interface 23, and gripper 1 maneuvered to a further position closer to target 100 to where snap-band 14, when closed or retracted, will at least partially encircle or otherwise coil about target 100. A further command may issue, e.g., using controller interface 23, commanding snap-band controller 20 to move, e.g., “snap,” snap-band 14 into its closed position to at least partially encircle and capture target 100, e.g., using one or more snap actuation motors or actuators 21.

In embodiments, the command to move the snap-band into its closed position causes snap-band 14 to quickly coil about target 100, e.g., take around one second or less for a length of snap-band 14 of around 12 inches or less.

With respect to a fully or partially engaged gripper which is gripping target 100, snap-band controller 20 may be commanded to move snap-band 14 into its open position which will retract snap-band 14 from captured target 100 and release gripper 1 from the captured target 100, e.g., by using snap-band motor 22 operatively connected to snap-band 14 and controller interface 23.

A released gripper 1 may be commanded to capture a new target by maneuvering gripper 1 proximate the new target, which may be in space; commanding snap-band controller 20 to move snap-band 14 into its open position, if it is not already in its open position; maneuvering gripper 1 to a further position closer to the new target to where snap-band 14, when closed, at least partially encircles the new target; and commanding snap-band controller 20 to move snap-band 14 into its closed position to at least partially encircle the new target.

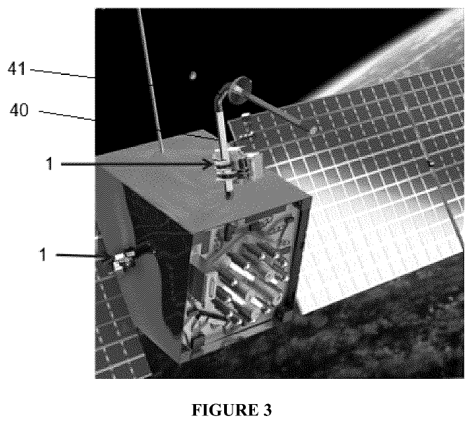

In embodiments, an engaged gripper 1 may detach snap-band 14 from target 100, leaving the detached snap-band 14 on the captured target by detaching snap-band 14 from housing 10 and/or from snap-band controller 20. Gripper 1 may be supplied with a replacement snap-band 14 once snap-band 14 has detached from gripper 1.

Where housing 10 further comprises support junction 16 and support arm 40 (FIG. 3) operatively connected to support junction 16, support arm 40 may be used to maneuver gripper 1 proximate target 100. In addition, peripheral 41 (FIG. 3), e.g., a camera, may be operatively connected to support arm 40 and used as an aid in maneuvering gripper 1 proximate target 100.

In embodiments, one or more snap-bands 14 are primarily positioned by motorized rollers into and between the open state, the externally coiled state (after being “snapped”), and the internally coiled state. Typically, snap-band 14 is “snapped” by one or more actuators 21 which forcibly flatten a section of the curved width of an open snap-band 14 causing the external section of snap-band 14 to coil. A guide may be present and used to forcibly curve the flat width of a coiled snap-band 14 which causes it to be straighten during snap-band extension to the open position.

The foregoing disclosure and description of the inventions are illustrative and explanatory. Various changes in the size, shape, and materials, as well as in the details of the illustrative construction and/or an illustrative method may be made without departing from the spirit of the invention.

1. A gripper, comprising:
a) a housing;
b) a power supply disposed at least partially within the housing;
c) a controllable snap-band comprising a selectable, controllable open position and selectable, controllable closed position, the controllable snap-band disposed about and extending from an external surface of the housing; and
d) a snap-band controller disposed at least partially within the housing, the snap-band controller operatively connected to the power supply and operatively connected to the controllable snap-band, the snap-band controller operative to selectively move the snap-band between the snap-band's open position and the snap-band's closed position.

2. The gripper of claim 1, wherein the controllable snap-band is selectively detachable from the snap-band controller and from the housing.

3. The gripper of claim 1, wherein the controllable snap-band comprises a cover.

4. The gripper of claim 1, wherein the controllable snap-band is configured to accommodate encircling an irregular shape.

5. The gripper of claim 1, wherein the gripper is configured to accommodate sporadic motion between the housing and a moving target.

6. The gripper of claim 1, wherein the controllable snap-band comprises a closing reaction time of around one second or less to prevent a touched target from reactively moving away.

7. The gripper of claim 1, wherein the controllable snap-band comprises a plurality of controllable snap-bands.

8. The gripper of claim 1, further comprising a predetermined set of payload electronics (30) disposed at least partially within the housing.

9. The gripper of claim 1, further comprising an electro-magnet (44) disposed at least partially exposed through the housing.

10. The gripper of claim 1, wherein the snap-band controller further comprises:
a) a snap actuation motor;
b) a snap-band motor or actuator operatively connected to the controllable snap-band; and
c) a control interface.

11. The gripper of claim 1, further comprising a support junction disposed about a surface of the housing.

12. The gripper of claim 11, further comprising:
a) an arm connected to the support junction; and
b) a camera connected to the arm.

13. A method of connecting two objects in space, comprising:
a) maneuvering a gripper proximate a target, the gripper comprising:
i) a housing;
ii) a power supply disposed at least partially within the housing;
iii) a controllable snap-band comprising a selectable open position and closed position, the controllable snap-band disposed about an external surface of the housing; and
iv) a snap-band controller disposed at least partially within the housing, the snap-band controller operatively connected to the power supply and operatively connected to the controllable snap-band, the snap-band controller operative to selectively move the snap-band between the open position and the closed position;
b) commanding the snap-band controller to move the snap-band into its open position;
c) maneuvering the gripper to a further position closer to the target to where the controllable snap-band, when closed, at least partially encircles the target; and
d) commanding the snap-band controller to move the controllable snap-band into its closed position to at least partially encircle and capture the target.

14. The method of claim 13, wherein the command to move the controllable snap-band into its closed position causes the snap-band to coil about the target in no more than one second.

15. The method of claim 13, further comprising:
a) commanding the snap-band controller to move the controllable snap-band into its open position; and
b) retracting the controllable snap-band from the captured target to release the gripper from the captured target.

16. The method of claim 15, further comprising commanding a released gripper to capture a new target by:
a) maneuvering the gripper proximate the new target;
b) commanding the snap-band controller to move the controllable snap-band into its open position, if it is not already in its open position;
c) maneuvering the gripper to a further position closer to the new target to where the controllable snap-band, when closed, at least partially encircles the new target; and
d) commanding the snap-band controller to move the controllable snap-band into its closed position to at least partially encircle the new target.

17. The method of claim 13, further comprising leaving the controllable snap-band on the captured target by detaching the controllable snap-band from the housing and from the snap-band controller.

18. The method of claim 17, wherein the snap-band controller comprises a snap-band actuator and detaching the controllable snap-band from the gripper comprises disengaging the snap-band actuator so that an external pull-off force between the target and the gripper causes the snap-band to be fully separated from the gripper while the snap-band remains wrapped around the target.

19. The method of claim 17, further comprising supplying the gripper with a replacement controllable snap-band once the controllable snap-band has detached from the gripper.

20. The method of claim 13, wherein the housing further comprises a support disposed about an external surface of the housing, the support comprising a support arm, the method further comprising:
a) attaching the support arm to the support; and
b) using the support to maneuver the gripper proximate the target.
